(19) United States
(12) Patent Application Publication
(10) Pub. No.: US 2001/0032529 A1
(43) Pub. Date: Oct. 25, 2001

(54) Positive locking systems for socket ratchet wrenches

(76) Inventors: Franklin E. Barnett, La Junta, CO (US); Brian D. Smith, Highlands Ranch, CO (US)

Correspondence Address: BRIAN D. SMITH, P.C., 1200 SEVENTEENTH ST., SUITE 1700, DENVER, CO, 80202, US

(21) Appl. No.: 09/792,445

(22) Filed: Feb. 23, 2001

Related U.S. Application Data
(60) Provisional application No. 60/184,967, filed on Feb. 25, 2000.

(51) Int. Cl. B25B 13/00

(52) U.S. Cl. 81/59.1

(57) ABSTRACT

Socket and ratchet wrench combinations having systems for positively locking the socket to the ratchet wrench are disclosed. The disclosed sockets have at least one circumferential axially aligned annular groove extending about their exterior surface with one or more openings in the side of the groove(s) for receiving sections on the ratchet wrench which cooperate with the socket's groove(s) to positively lock the socket to the wrench.

### CROSS REFERENCE TO RELATED APPLICATIONS

This application is a nonprovisional application claiming the benefit under 35 USC 119(e) of U.S. provisional application Ser. No. 60/184,967, filed on Feb. 25, 2000.

### TECHNICAL FIELD OF THE INVENTION

The invention relates generally to socket ratchet wrenches, and more particularly to means for positively locking sockets to said ratchet wrenches.

### BACKGROUND OF THE INVENTION

The prior art is replete with socket retention systems for ratchet wrenches, the most popular of which is the spring loaded ball/detent system in which a spring loaded ball built into the side of the square male drive post of a ratchet wrench is received in a detent provided on the inside surface of the socket's square hole for receiving the male drive post. A push button locking mechanism for this system has also been developed and is commonly found in many Sears Craftsman ratchet wrenches.

While these systems work quite well for ratchet wrenches utilizing the square male drive post system, they will not work on the newer “pass through” ratchet wrenches which allow the shaft of a bolt to pass through the head of the wrench and which thereby eliminate the need for deep well sockets. Accordingly, other types of socket retention systems have been developed for “pass through” ratchet wrenches such as the rubber grommet type system of the MAC Tools Flex wrench ratchet wrench and the wire/groove type systems used in the Eliminator made by Danaher Corporation and the O'Ratchet made by Summit Tools of Texas.

While all of these systems undoubtedly work to some degree at least until they wear out or require adjustment, none is believed to disclose or suggest the socket ratchet wrench of the present invention which provides positive locking of the socket to the ratchet wrench head and does so by preferably but not necessarily using a permanent magnet in its operation. The use of a permanent magnet provides the following advantages:

(1) Stronger, smoother, less expensive and longer lasting “pass through” ratchet wrenches due to the use of a magnetic ratchet system that uses components such as ball bearing pawls which are much stronger and provide much smoother operation than conventional ratcheting mechanisms. Such a magnetic ratchet system is disclosed in our U.S. Pat. No. 5,970,825 and in our copending U.S. patent application Ser. No. 09/227,627, both of which are hereby incorporated by reference. Longer ratchet life is facilitated because the system does not require sharp ratchet teeth which can break nor any springs for pushing a pawl into engagement with the ratchet wheel which eventually wear out.

(2) Magnetic holding or attraction of the socket in or on the wrench's ratchet wheel, i.e. on the square male drive post of the ratchet wheel of a conventional socket wrench or in the hole of the newer “pass through” ratchet wrenches.

(3) Facilitates positive locking of the socket to the wrench head by magnetically holding or attracting the socket in or on the wrench.

### SUMMARY OF THE INVENTION

The present invention addresses the foregoing concerns by providing provides a socket and wrench combination including a wrench socket having first locking means on its exterior surface and a wrench for receiving the socket and having second locking means for cooperating with the first locking means of the socket to positively lock the socket to the wrench. Positive locking of the socket to the wrench is preferably provided at least 90% of the time as the socket is rotated relative to the wrench head during normal use of the wrench and more preferably 100% of the time.

In a preferred embodiment, the socket's first locking means includes a circumferential axially aligned groove provided in the outside surface of the socket which as indicated extends circumferentially around the socket and is axially aligned about the socket's rotational axis, i.e. the axis the socket rotates about when it is inserted in the wrench head. The groove has one or more side openings for receiving the wrench's second locking means. The wrench head locking means includes one or more fixed sections referred to herein as flats which are received in the groove through the groove's side opening(s) when the socket is inserted and rotated in the wrench head. The flat(s) ride in the groove when the socket is rotated relative to the wrench head and, as such, positively lock the socket to the wrench head, i.e. while they are riding in the groove. When it is desired to remove the socket from the wrench head, the socket is rotated until the flats(s) line up with the groove's side opening(s) at which point the socket may be removed from the wrench head.

In a particularly preferred embodiment, the wrench of the present invention additionally includes a permanent magnet for attracting the socket after it is at least partially inserted in or mounted on the wrench head. The preferred magnet may be the ring magnet described in our U.S. Pat. No. 5,970,825 and in our copending U.S. patent application Ser. No. 09/227,627, both of which are hereby incorporated by reference. As described therein, the magnetic force of the ring magnet attracts the socket after it is received by (i.e. mounted on or inserted in) the wrench head of the wrench.

As also described in our foregoing patent and patent application, the magnetic force provided by the ring magnet is generally strong enough to hold the socket in the wrench in most situations. However, if the socket were to jam or otherwise stick to a nut or bolt head, the magnetic force may be easily exceeded if one pulls on the wrench in an attempt to loosen or free the socket from the nut or bolt head. Accordingly, the positive locking systems of the present invention will enable one to pull on the wrench and free the jammed socket without having to worry about pulling the wrench off the socket.

The positive locking systems of the present invention can also be incorporated into an extension bar(s), the weight of which often exceeds or comes close to exceeding the strength of the ring magnet or for that matter the strength of a conventional wrench's socket retention means which thereby causes the extension to fall off the wrench head. With the extension locked to the wrench head as provided by the present invention such falling off of the extension will no longer be a problem regardless of the socket retention means employed.

As mentioned, the locking systems of the present invention are preferably used in conjunction with a permanent magnet which attracts the socket and preferably holds it in place, actually pulls the socket inwardly into the wrench head towards or against the ratchet wheel. In addition to holding the socket in the wrench when it is in an unlocked position, it has been found that the inward pulling or holding of the socket by the force of the magnet also prevents the socket from moving outwardly or upwardly in the wrench head even when the socket is positively locked to the wrench. Such upward movement could occur if the wrench were not provided with a magnet or some or means for holding the socket in place if, for example, the wrench were held in an upside down position when the socket's flat sides and flats of the wrench cap happen to align. Such upward movement is undesirable because it can interfere with the ratcheting operation of the wrench and cause the wrench to jam.

Be that as it may, the positive locking systems of the present invention do not require a permanent magnet and will work with conventional wrenches having conventional socket retention means such as the conventional spring loaded ball/detent mechanism or the rubber grommet type system of the Mac Tools Flex wrench ratchet wrench or the wire mechanisms used in the Eliminator made by Danaher Corp and the O'Ratchet made by Summit Tools of Texas. It is believed that the socket retention systems of the conventional systems can also hold or be slightly modified to hold the socket in the wrench after it is positively locked to the wrench to prevent the socket from moving upwardly in the wrench head and causing the ratcheting mechanism to jam.

Therefore, while all disclosed embodiments of the present invention use the magnetic force of a permanent magnet to magnetically attract or hold a socket in place that has been received or inserted into the wrench, the scope of the present invention is not intended to be limited to such wrenches and it is specifically considered to be within the scope of the present invention to cover the use of positive locking systems on any ratchet wrench including those employing conventional spring loaded pawl ratchet mechanisms and conventional socket retention mechanisms such as those described above.

### BRIEF DESCRIPTION OF THE DRAWINGS

The invention will be more readily understood by reference to the accompanying drawings wherein like reference numerals indicate like elements, and wherein reference numerals sharing the same last two digits identify similar corresponding elements (except where the elements are obviously different) throughout the various disclosed embodiments in this application and in U.S. patent application Ser. No. 09/227,627 which is hereby incorporated by reference, and in which:

FIG. 1 is a perspective view of a socket and ratchet wrench combination provided with a positive locking system of the present invention.

FIG. 2 is an exploded perspective view showing the components of the socket and ratchet wrench combination of FIG. 1.

FIG. 3 is a bottom plan view of the wrench head of the wrench of FIG. 1.

FIG. 4 is a bottom plan view of the wrench head of the wrench of FIG. 3 which additionally shows the socket of FIG. 1 inserted in the wrench and the nut of FIG. 1 inserted in the socket.

FIG. 5 is a cross sectional view taken along lines 5-5 of FIG. 4.

FIG. 6 is a cross sectional view similar to that of FIG. 7. However, in FIG. 6 the socket has been rotated slightly from its position shown in FIG. 7 so that the flats of the wrench's cap are located in the annular groove of the socket to prevent one from being able to pull the socket out of the wrench.

FIG. 7 is a cross sectional view taken along lines 7-7 of FIG. 4.

FIG. 8 is a side elevation view of the socket of FIG. 1.

FIG. 9 is a bottom plan view of the socket of FIG. 8.

FIG. 10 is a perspective view of the ratchet wrench of FIG. 1 shown, however, with a different socket of the present invention which has been designed to provide 100% positive locking of the socket to the wrench.

FIG. 11 is an enlarged perspective view of the socket of FIG. 10.

FIG. 12 is a side elevation view of the socket of FIGS. 10 and 11.

FIG. 13 is a bottom plan view of the socket of FIGS. 10 and 11.

FIG. 14 is front elevation view of the socket of FIGS. 10 and 11.

FIG. 15 is a cross sectional view taken along lines 15-15 of FIG. 14.

FIG. 16 is a bottom plan view of the wrench head of the wrench of FIG. 1 which also shows the socket of FIGS. 10 and 11 partially inserted into the wrench head and the nut of FIG. 10 inserted in the socket.

FIG. 16A is an end elevation view of the wrench head and partially inserted socket depicted in FIG. 16.

FIG. 17 is a cross sectional view taken along lines 17-17 of FIG. 16.

FIG. 18 is a cross sectional view taken along lines 18-18 of FIG. 16.

FIG. 19 is a cross sectional view similar to that of FIG. 18 showing, however, the socket rotated 90 degrees from its position in FIG. 18.

FIG. 20 is a bottom plan view of the wrench head of the wrench of FIG. 1 which also shows the socket of FIGS. 10 and 11 fully inserted into the wrench head and the nut of FIG. 10 inserted in the socket.

FIG. 20A is an end elevation view of the wrench head and fully inserted socket depicted in FIG. 16.

FIG. 21 is a cross sectional view similar to that of FIG. 22 showing, however, the socket rotated 90 degrees from its position in FIG. 22.

FIG. 22 is a cross sectional view taken along lines 22-22 of FIG. 20.

FIG. 23 is a cross sectional view taken along lines 23-23 of FIG. 20.

### DETAILED DESCRIPTION OF PREFERRED EMBODIMENTS

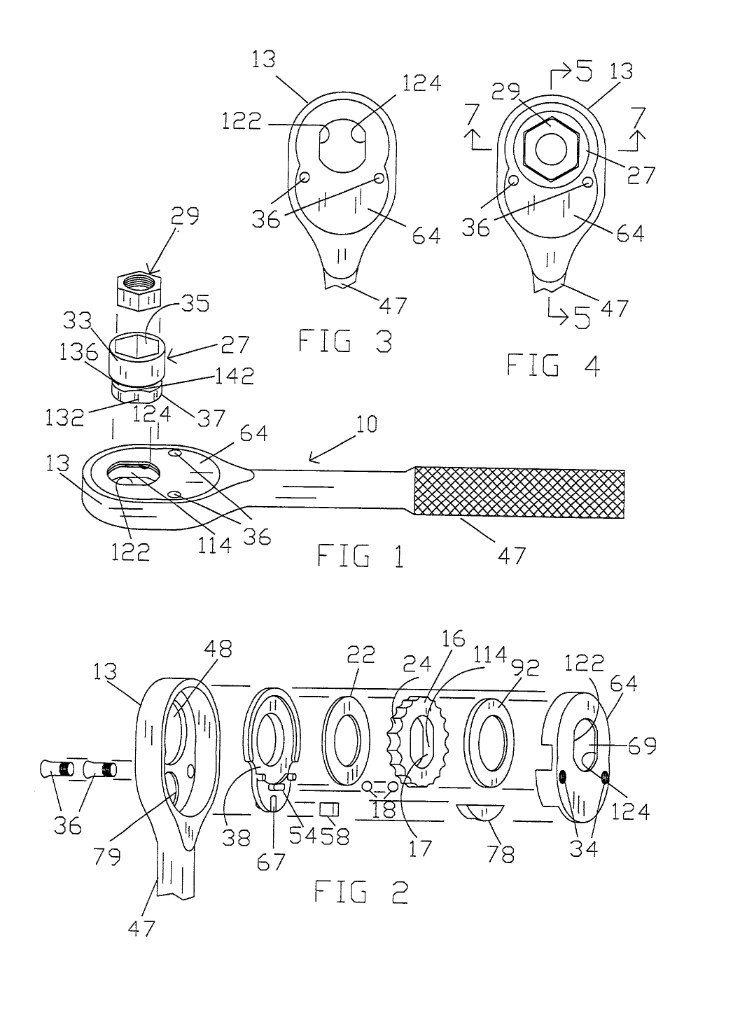

FIGS. 1-9 illustrate a socket and ratchet wrench combination of the present invention having a unique locking mechanism for positively locking the socket to the wrench after the socket is received by the wrench, i.e. fully inserted into the cut-out 17 of ratchet wheel 16.

The ratchet mechanism is similar to that of FIGS. 41-46 of U.S. patent application Ser. No. 09/227,627 which is hereby incorporated by reference, and therefore is not described in detail here. There are, however, some minor differences in the ratchet wheels of this embodiment and that of FIGS. 41-16 which should be discussed. As shown in FIG. 1, the sides of ratchet wheel 16 are flat and not provided with the raised portion rim 619 shown in FIG. 42. Cut-out 17 of this embodiment is also shaped differently than the cut-out 617 of FIG. 42 which is hex-shaped. As shown, cut-out 17 has two opposing sides referred to herein as flat sides 112, 114 which are the two opposing sides of a hexagon. As can be visualized from the figures, the remaining four sides of what would be a hexagon in this embodiment have been rounded to reduce manufacturing costs. Functionally, the two shapes, i.e. the shape of cutout 17 referred to herein as a “two sided hexagon” and the hexagon of cut-out 617 are the same, i.e. the operation and strength of the two cut-outs are believed to be the same or very similar.

Washer 92 of this embodiment is also simpler than washer 692 in that it no longer has a raised rim such as raised rim 641. Cap 64 while similar to cap 664 differs in that instead of being provided with a circular cap hole like cap hole 669 it is provided with a two-sided hexagon shape that is identical to that of cut-out 17. The flat sides of this two-sided hexagonal cap hole 69 are referred to herein as flats or sections 122, 124 and as described below, they play an important role in locking socket 27 to wrench 10.

Turning now to socket 27, it will be appreciated from FIGS. 1, 7 and 8 that unlike the hex shape of socket 627 the driven end 37 of socket 27 is provided with a two sided hexagonal shape so that it can be received in the identically shaped cutout 17 of ratchet wheel 16 and driven thereby. It will also be appreciated that the flat sides of driven end 37 are identified by numerals 132, 134. In addition, it will be appreciated that socket 27 is provided with an annular groove 136 which extends circumferentially around the exterior of socket 27 and is axially aligned about the socket's longitudinal rotational axis. As shown, groove 136 is located on the upper end of the socket's driven end 37 actually between the driven end 37 and the socket's driving end 33. As also shown, flat surfaces 132, 134 extend into the sides of groove and thereby define side openings 142, 144 of the groove, the importance of which will be described shortly.

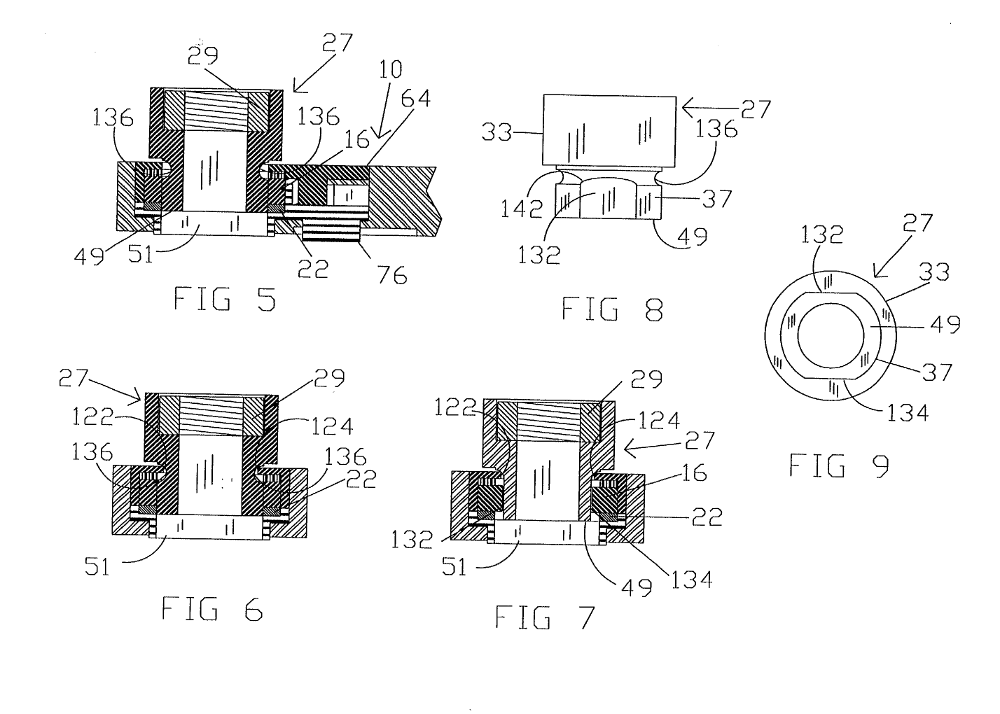

To insert socket 27 into the wrench via cap hole 69, the socket is first positioned so that its flat sides 132, 134 line up with flats 122, 124 of cap 64 and sides 112, 114 of the ratchet wheel 16. The socket is then inserted into the wrench through cap hole 69 so that it is positioned as shown in FIGS. 5 and 7. However, there is no need to push the socket into the wrench since the magnetic force provided by magnet 22 actually pulls the socket into the position of FIGS. 5 and 7 as soon as it is inserted through cap hole 69. The magnetic force also holds the socket in this position until it is decided to remove the socket. If, however, the socket is rotated slightly as shown in FIG. 6, flats 122, 124 of the wrench's cap 64 will ride or move into the annular groove 136 of the socket and thereby prevent one from being able to pull the socket out of the wrench. When the socket is in this position it is considered to be “positively locked” to the wrench as the term is used herein.

Such rotation of the socket to positively lock the socket to the wrench can be provided by simply turning or rotating the socket after it is inserted in the wrench via cap hole 69. However, those skilled in the art will appreciate that positive locking will also occur automatically when a return stroke is made with the wrench since the socket rotates in the wrench's head 13 (i.e. relative to the wrench) when a return stroke is made with the wrench. Thus, it will be appreciated that the socket will generally be positively locked to the wrench while it is being used. Indeed, the only time that the socket will not be locked to the wrench is when the flat sides 132, 134 of the socket happen to line up with flats 122, 124 of the cap which is estimated to occur less than 5% of the time. However, even when this occurs it will be appreciated that the magnet will still hold the socket in the wrench.

While as indicated the socket will normally be positively locked to the wrench after it has been used, if one wants to remove the socket from the wrench one merely has to rotate or turn the socket until the flat sides 132, 134 of the socket line up with the flats 122, 124 of the cap. One may then pull on the socket to remove it from the wrench. The socket can also be pushed out of the wrench by simply pushing on its end edge 49 through hole 51.

As indicated above, the positive locking provided by the present invention is highly desirable since it insures that the socket will not be left on a bolt head or nut when the wrench is lifted off the nut or bolt head. It also allows the user to pull on the socket with the wrench to free the socket if it happens to jam or otherwise stick to a nut or bolt head. Positive locking also insures that long socket extension arms provided with the locking system of the present invention will not fall out of the wrench which is a problem in conventional wrenches due to the weight of such extensions.

It will also be appreciated that positive locking of the socket to the wrench (which occurs approximately 95% of the time in the embodiment of FIGS. 1-9 as indicated above) can be increased up to perhaps 98% of the time by orienting flats 122, 124 and the corresponding flat sides 132, 134 of the socket and 112, 114 of the wheel at a slight angle to each other so that the socket can only be inserted and removed in one position for every 360 degree rotation of the socket, i.e. inserted in one position for each complete turn of the socket. This could also be accomplished by providing the wrench with only one flat and the socket and wheel with only one corresponding flat side. As those skilled in the art will appreciate, these arrangements differ from the embodiment of FIGS. 1-8 which allows insertion and removal of the socket in two positions (180 degrees apart) for every 360 degree rotation of the socket.

As mentioned above, ring magnet 22 holds the socket in the wrench when it is in an unlocked position, i.e. when flats 122, 124 line up with flat sides 132, 134 of the socket. In addition, it has been found that this holding action or inward pulling of the socket by the force of the magnet also prevents the socket from moving outwardly or upwardly in the wrench head even when the socket is positively locked to the wrench. Such upward movement could occur if the wrench were not provided with a magnet or some other socket retention means for holding the socket in place if, for example, the wrench were held in an upside down position when the socket's flat sides and flats of the wrench cap happen to align. Such upward movement is undesirable because it can interfere with the ratcheting operation of the wrench and cause the wrench to jam. Accordingly, it is important that the wrench head be provided with a magnet such as ring magnet 22 or some other socket retention means for holding the socket in place even when it is positively locked to the wrench head. As previously mentioned, socket retention means such as the conventional spring loaded ball/detent mechanism or the rubber grommet type system of the Mac Tools Flex wrench ratchet wrench or the wire mechanisms used in the Eliminator made by Danaher Corp and the O'Ratchet made by Summit Tools of Texas should be capable (perhaps with some slight modification) of holding the socket in place to prevent the socket from moving upwardly in the wrench head even when it is positively locked to the wrench head.

It should also be mentioned that positive locking of wrench 10 is provided in both directions in which the wrench can be operated, i.e. both the clockwise and counterclockwise (also referred to as forward and reverse directions) which enable tightening and untightening of the nut or bolt head being threaded with the wrench. The mechanism for reversing the direction in which the wrench is operation including the reversing member 38 is disclosed in our U.S. patent application Ser. No. 09/227,627 which has been incorporated by reference in this disclosure.

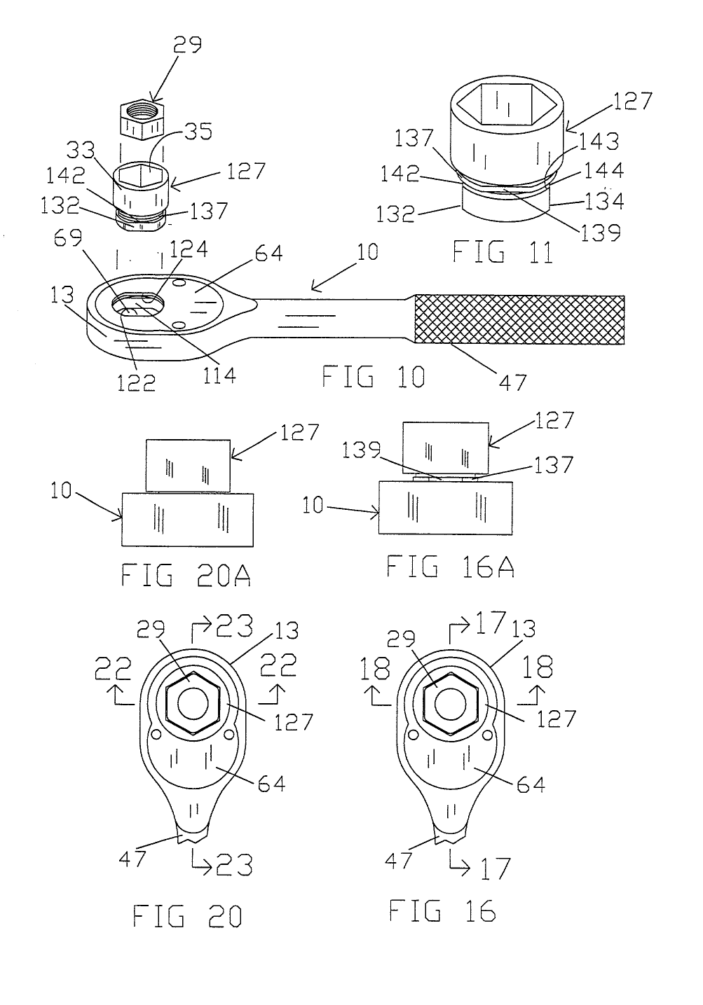

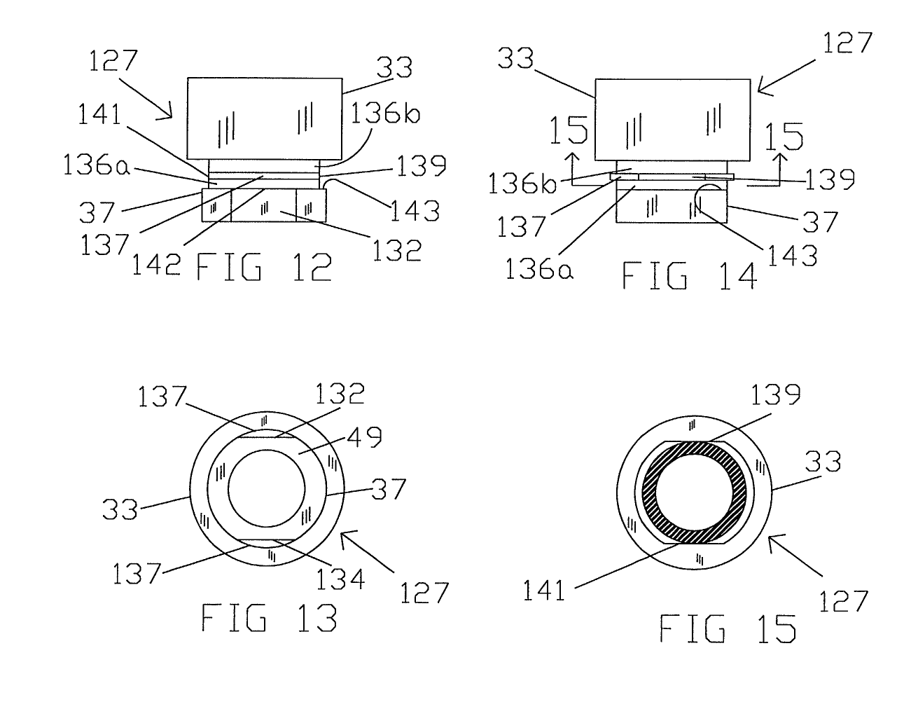

FIGS. 10-23 illustrate a socket 127 of the present invention which has been designed for use with wrench 10 of FIGS. 1-9 to provide 100% positive locking, i.e. locking of the socket to the wrench at all times and in both directions in which the wrench is used, i.e. both the forward and reverse directions.

As shown in FIGS. 11-15, socket 127 is similar to socket 27 of the previous embodiment but instead of being provided with a single annular groove 136 socket 127 is provided with a pair of annular grooves 136(a) and 136(b) which are separated by a central ridge 137. As also shown, central ridge 137 is provided with a pair of flat surfaces or flats 139, 141 which are positioned at right angles to flat sides 132, 134 of socket 127 as shown in FIGS. 12-15.

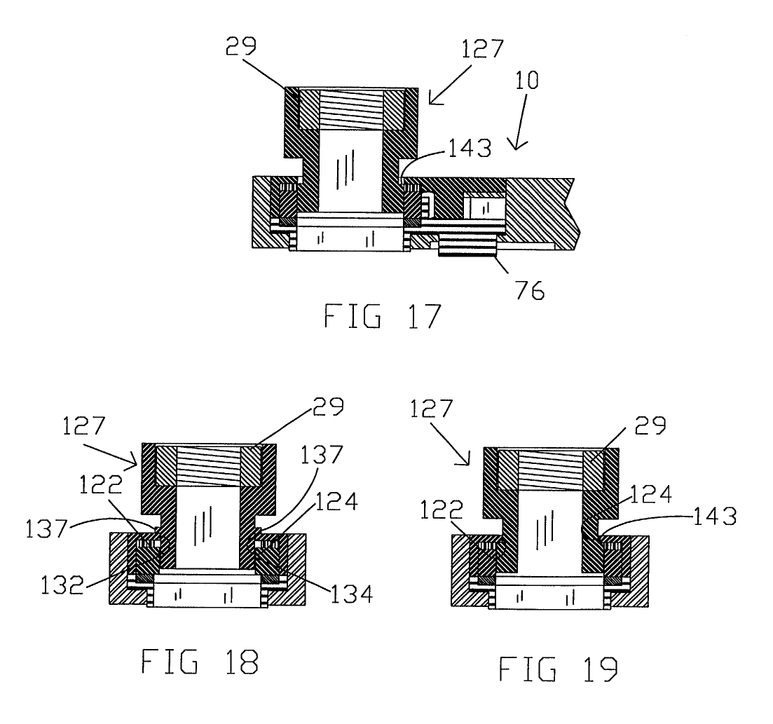

FIGS. 16-23 illustrate the process for inserting socket 127 into wrench 10 as well as the various positions of the wrench's components as the socket is inserted into the wrench. Similar to socket 27, socket 127 is first positioned so that its flat sides 132, 134 line up with flats 122, 124 of the wrench's cap 64 and sides 112, 114 of the wrench's ratchet wheel 16. The socket is then inserted into the wrench through cap hole 69 as shown in FIGS. 17, 18 so that its center ridge 137 rests against flats 122, 124 of the wrench's cap 64 (See FIG. 18). The magnetic force provided by the magnet 22 will hold the socket in this position until it is fully inserted into the wrench which is facilitated by turning the socket 90 degrees. This 90 degree turn (in addition to causing flats 112, 124 of the cap to ride or move through the socket's annular groove 136a) aligns flats 139, 141 of the socket's center ridge with flats 122, 124 of the cap as shown in FIG. 19 and therefore puts the socket in a position which allows the magnetic force of the wrench to pull the socket fully into the wrench as shown in FIG. 21 (FIGS. 20 and 20A also). From these figures, it will also be appreciated that flats 122, 124 are now in position to ride or move through the second annular groove 136b. In addition, it will be appreciated that flats 139, 141 of the center ridge define the “second side openings” for the second annular groove 136b as that term is generically used in claim 13 appended hereto. As also indicated in claim 13, the second side openings also allow access to the first groove, i.e. groove 136a, from its other opposite side, i.e. the side of groove 136a defined by central ridge 137. In addition and as shown in FIGS. 11 and 12, access to first annular groove 136a is provided on the other side of the first groove by the socket's flat sides 132, 134 which define the “first side openings” 142, 144 for the first annular groove 136a as that term is used in claim 13.

In any event, once the socket is fully inserted into the wrench as shown in FIG. 21 it will be 100% positively locked to the wrench's head 13. If one tries to remove the socket by pulling upwardly on it while it is in the position of FIG. 21 the socket will only move outwardly to the position shown in FIG. 19 where the sidewall 143 of the annular groove 136a impacts against the underside of flats 122, 124 of the cap. Therefore, it will be appreciated that the socket cannot be removed unless it is rotated 90 degrees from its position shown in FIG. 19 to the position of FIGS. 17 and 18 which will permit the socket's removal by pulling or pushing it out of the wrench as described in connection with the previous embodiment.

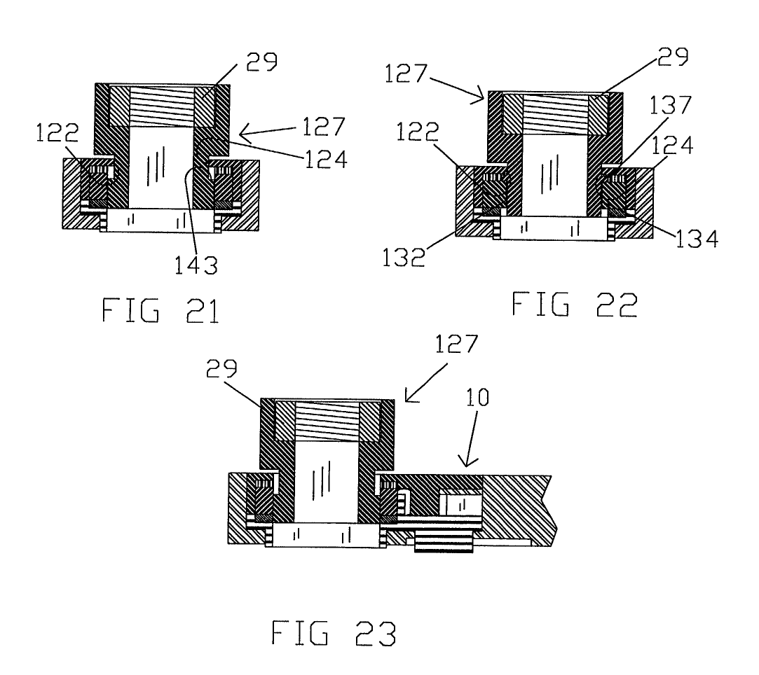

FIGS. 22 and 23 illustrate the position of socket 127 after it has been rotated 90 degrees from its position in FIG. 21. In this position, the socket's center ridge 137 is located directly under flats 122, 124 of the cap 64 (see FIG. 22) to prevent removal of the socket from the wrench head. While not shown, it will be appreciated that the center ridge will be in this position, i.e. located directly below flats 122, 124, approximately 95% of the time during normal use of the wrench, thereby preventing the socket from being pulled out of the wrench. It will also be appreciated that flats 122, 124 will be riding in groove 136b during normal use of the wrench as shown in FIGS. 22 and 23 and as previously mentioned if one attempts to pull the socket out of the wrench while flats 122, 124 are in groove 136b with the center ridge located below the flats, the center ridge will impact up against the underside of the flats 122, 124 to prevent the socket's removal from the wrench. It is only when flats 139, 141 of the center ridge 137 line up with flats 122, 124 of the cap as shown in FIG. 21 that the center ridge will not impact against flats 122, 124. However, as previously mentioned when this occurs the side wall 143 of the annular groove 136a will impact against flats 122, 124 to prevent the socket's removal from the wrench.

While wrench 10 is provided with two flats 122, 124 and two corresponding flat sides 112, 114 of the wheel as well as two corresponding flat sides of socket 127, it will be appreciated that three flats and three corresponding flat sides for the wheel and socket could also be provided which would be spaced 120 degrees apart. Such a wrench/socket combination might be desirable because it might make it easier to insert and remove the socket from the wrench since such a combination would only require a 60 degree turn instead of a 90 degree turn of the socket to move the flats through groove 136a to reach groove 136b. Initial insertion of the socket into the wrench would also be easier since it would only require a maximum turn of 120 degrees (instead of 180 degrees) to align the flat sides of the socket with the flats of the wrench cap.

From the foregoing, it will be appreciated that the present invention provides unique positive locking systems for socket and ratchet wrench combinations which are ideally suited for use in “pass through” socket and ratchet wrench combinations, particularly that using a permanent magnet and our magnetic ratchet as disclosed in our copending U.S. patent application Ser. No. 09/227,627.

The invention has been described in detail with reference to particular embodiments thereof, but it will be understood that various other modifications can be effected within the spirit and scope of this invention. For example, the positive locking system may be utilized in any socket and ratchet wrench combination including those developed for other “pass through” ratchet wrenches such as the rubber grommet type system of the MAC Tools Flex wrench ratchet wrench and the wire/groove type systems used in the Eliminator made by Danaher Corporation and the O'Ratchet made by Summit Tools of Texas. Indeed, it is believed that these wrenches can be provided with flats or similar type projections which ride in the grooves of the sockets used with these wrenches to provide these wrenches with positive locking capability.

We claim:

1. A socket and wrench combination comprising:
a wrench socket having first locking means on its exterior surface;
a wrench for receiving said wrench socket and having second locking means for cooperating with said first locking means of said socket to positively lock said socket to said wrench; and,
socket retention means for holding said socket in place to restrict outward movement of said socket in said wrench when said socket is positively locked to said wrench.

2. A socket and wrench combination as claimed in claim 1 wherein said socket retention means is provided by a permanent magnet mounted in said wrench which magnetically holds said socket in place to restrict outward movement of said socket along its rotational axis.

3. A socket and wrench combination as claimed in claim 1 wherein said socket retention means is provided by a member mounted in said wrench which is selected from the group of a wire, flexible grommet and spring loaded ball.

4. A socket and wrench combination as claimed in claim 1 wherein said first and second locking means cooperate to positively lock said socket to said wrench at least 90% of the time as the socket is rotated relative to the wrench head during normal use of the wrench.

5. A socket and wrench combination as claimed in claim 1 wherein said first and second locking means cooperate to positively lock said socket to said wrench 100% of the time as the socket is rotated relative to the wrench head during normal use of the wrench.

6. A socket and wrench combination as claimed in claim 1 wherein:
said first locking means includes a groove provided in said exterior surface of said socket which is axially aligned about said socket's longitudinal rotational axis; and
said second locking means includes one or more section(s) of said wrench for being received in said groove when said socket is received by the wrench, said groove and section(s) received therein cooperating to positively lock said socket to said wrench.

7. A socket and wrench combination as claimed in claim 2 wherein said permanent magnet magnetically pulls said socket into said wrench when said socket is inserted in said wrench.

8. A socket and wrench combination as claimed in claim 1 wherein:
said first locking means includes a groove provided in said exterior surface of said socket which is axially aligned about said socket's longitudinal rotational axis, said groove also having one or more side openings; and
said second locking means includes one or more sections of said wrench for being received in said groove through said groove's side opening(s) when said socket is rotated relative to said wrench, said groove and section(s) received therein cooperating to positively lock said socket to said wrench except when said section (s) align with said groove's side opening(s) at which point(s) said socket may be removed from said wrench.

9. A socket and wrench combination as claimed in claim 8 wherein said sections are rigidly affixed to said wrench.

10. A socket and wrench combination as claimed in claim 8 wherein said socket retention means includes a permanent magnet built into said wrench for magnetically attracting said socket to hold said socket in place when said socket is positively locked to said wrench.

11. A socket and wrench combination as claimed in claim 1 wherein:
said first locking means includes a pair of first and second annular grooves provided in said exterior surface of said socket which are separated by a central ridge, said first groove having one or more first side openings for accessing said first groove from one side of said first groove and one or more second side openings for accessing said first groove from its other opposite side, said second side openings being defined by said central ridge and also providing access to said second groove; and
said second locking means includes one or more sections of said wrench for being received in said first and second grooves through said grooves' first and second side opening(s) when said socket is inserted into and rotated relative to the wrench, said grooves and section(s) received therein cooperating to positively lock said socket to said wrench.

12. A socket and wrench combination as claimed in claim 11 wherein said first and second side openings are located from about 69 to about 90 degrees from each other as measured along the circumference of said socket.

13. A socket and wrench combination as claimed in claim 2 wherein said permanent magnet is a rare earth magnet.

14. A socket and wrench combination as claimed in claim 13 wherein said rare earth magnet includes neodymium.

15. A socket and wrench combination as claimed in claim 1 further comprising an elongated socket extension having said first locking means on its exterior surface.

16. A socket and ratchet wrench combination of the type for receiving and allowing an externally threaded member to pass through said socket as the nut is driven on the threaded member with said ratchet wrench comprising:
a pass through wrench socket having first locking means on its exterior surface; and,
a pass through ratchet wrench for receiving said wrench socket and having second locking means for cooperating with said first locking means of said socket to positively lock said socket to said wrench; and
a permanent magnet built into said ratchet wrench for magnetically attracting said socket to hold said socket in place when it is positively locked to said wrench.

17. A socket and ratchet wrench combination comprising:
a wrench socket having a driving end defining a drive socket cavity for engagingly receiving a nut and the like to be driven and a driven end defining a through hole passageway in communication with said drive socket cavity for receiving and allowing an externally threaded member to pass through said socket as the nut is driven on the threaded member with said ratchet wrench, said wrench socket also having first locking means on its exterior surface; and,
a ratchet wrench including:
an elongated wrench body;
a ratchet wheel having an outer rim defining detents and an inner cut-out axially aligned about the rotational axis of said wheel for engagably receiving said driven end of said wrench socket, said cut-out extending through said ratchet wheel to allow an externally threaded member to pass there through as a nut is driven on the threaded member with said ratchet wrench and said socket;
floating pawl means;
said wrench body defining a chamber in which said ratchet wheel is received for rotation relative to said wrench body, said wrench body also defining pocket means opening into said chamber for receiving said floating pawl means, said ratchet wheel rim defining said detents and said pocket means being sized and configured to facilitate movement of said floating pawl means into a drive position when said wrench body is rotated in a first direction relative to said ratchet wheel, said sizing and configuring also facilitating the release of said floating pawl means from the drive position when said wrench body is rotated in a second opposite direction, said floating pawl means when in the drive position being sandwiched between a detent of said ratchet wheel rim and said pocket means to prevent said wrench body and said ratchet wheel from rotating relative to each other, said floating pawl means when released permitting said wrench body and said ratchet wheel to rotate relative to each other;
magnet means for facilitating movement of said floating pawl means into the drive position when said wrench body is rotated in the first direction, said magnet means also providing magnetic force for holding said socket in said cut-out of said ratchet wheel; and, second locking means for cooperating with said first locking means of said socket to positively lock said socket to said wrench, said first and second locking means cooperating to positively lock said socket to said wrench when said first and
second locking means are moved in a predetermined manner relative to each other after said socket is received by said wrench.

18. A socket and ratchet wrench combination as claimed in claim 17 further comprising socket retention means for holding said socket in place to prevent outward movement of said socket in said wrench when said socket is positively locked to said wrench.

19. A socket and ratchet wrench combination as claimed in claim 18 wherein said socket retention means is provided by a permanent magnet mounted in said wrench.

20. A socket and ratchet wrench combination as claimed in claim 18 wherein said socket retention means is provided by a member mounted in said wrench which is selected from the group of a wire, flexible grommet and spring loaded ball.
